(19) United States
(12) Patent Application Publication
(10) Pub. No.: US 2003/0080609 A1
(43) Pub. Date: May 1, 2003

(54) Energy-absorbing flexible polymer vehicle wheel

(75) Inventor: Thomas A. Darnell, Wichita, KS (US)

Correspondence Address: HOVEY WILLIAMS TIMMONS & COLLINS, 2405 GRAND BLVD., SUITE 400, KANSAS CITY, MO, 64108

(73) Assignee: HIPER TECHNOLOGY, INC.

(21) Appl. No.: 10/029,790

(22) Filed: Oct. 29, 2001

(51) Int. Cl. B60B 25/00

(52) U.S. Cl. 301/95.11

(57) ABSTRACT

A lightweight, energy-absorbing, flexible vehicle wheel (12) constructed from an injection molded engineered polymer, such as, for example, a toughened nylon reinforced with carbon fibers, glass fibers, or kevlar fibers, wherein the wheel (12) may be embodied in either modular or one-piece construction. In a modular embodiment, the wheel (12) comprises broadly comprises an inboard wheel half (14); an outboard wheel half (16); a center section (18); a bead lock ring (20); and a removable mud plug (22). Stiffening ribs (38,54,55) and varying cross-sectional thicknesses are provided in the inboard and outboard wheel halves (14,16) for controlling stiffness; gaskets (70), O-rings (71), or dynamic u-cup seals (73) are provided for sealing contact surfaces (40,44,64,66); and an interlocking alignment mechanism (62,82) is provided for aligning the bead ring (20) on the outboard wheel half (16).

### BACKGROUND OF THE INVENTION

1. Field of the Invention

The present invention relates to wheels for vehicles. More particularly, the present invention relates to a lightweight, energy-absorbing, flexible vehicle wheel constructed from an injection molded engineered polymer, such as, for example, a toughened nylon reinforced with carbon fibers, glass fibers, or kevlar fibers, wherein the wheel may be embodied in either modular or one-piece construction, and comprises ribs and varying cross-sectional thicknesses for controlling stiffness; O-rings, gaskets, or dynamic u-cup seals for sealing contact surfaces; an alignment mechanism for facilitating bead ring alignment; and a mud plug having a quick release mechanism for quick removal.

2. Description of the Prior Art

It is often desirable to provide a vehicle with lightweight wheels able to withstand substantial and repeated impacts and other operating stresses without significant negative effect or performance degradation. This is true for almost all vehicles, and is particularly true for off-road and off-road racing vehicles that travel over punishingly uneven terrain and that may even become substantially airborne at times, thereafter crashing back to earth. Such conditions and uses, it will be appreciated, subject the wheels to significant stresses.

Wheels constructed from both aluminum and steel are well-know in the art. Unfortunately, metal wheels suffer from a number of disadvantages and limitations, including a generally heavier weight and a lack of energy-absorbing flexibility. Aluminum, for example, though a relatively lightweight metal, when used in wheel construction must typically be made undesirably thick and correspondingly heavy to have the strength required to withstand the aforementioned punishing driving conditions. Unfortunately, aluminum has a relatively low yield strength, meaning it is easily permanently deformed. When such deformation occurs, tire leakage or de-beading may result. Those with skill in the arts of off-road travel and off-road racing will appreciate these drawbacks and limitations and the expensive necessity of maintaining a supply of and frequently replacing aluminum wheels. Steel, though stronger than aluminum, is also undesirably heavier and similarly subject to permanent deformation. It will also be appreciated, from a manufacturing standpoint, that steel and aluminum may, at times, be difficult to acquire, and can be relatively difficult and dangerous to work. Furthermore, delivery costs for the relatively heavy metal wheels can negatively impact profit margins.

Engineered polymer wheels are known in the art which provide an alternative to metal wheels in some applications, particularly high-performance bicycle, motorcycle, and race car applications, where their relatively light weight is highly desirable. Unfortunately, existing polymer wheels typically have little, if any, energy-absorbing flexibility. Thus, rather than deform, as metal wheels are wont to do, they often crack or fracture under similar stresses, being therefore suitable only for use on very lightweight vehicles or very smooth, managed race courses.

Existing wheels, whether constructed from a metal or a polymer, suffer from a number of additional disadvantages as well, including bead rings that are difficult to align and install; center sections in modular wheels that are unsealed or poorly sealed; and interior cavities wherein mud and debris become packed due to lack of or unsophisticated mechanisms for preventing such a build-up which could add undesired weight, unbalance the wheel, and prevent or hinder access to the mechanisms, such as lug bolts and nuts, coupling the wheel to the vehicle.

Due to the above-identified and other problems and disadvantages in the art, a need exists for an improved wheel.

### SUMMARY OF THE INVENTION

The present invention provides a distinct advance in the art of wheels for vehicles. More particularly, the present invention provides a lightweight, energy-absorbing, flexible vehicle wheel constructed from an injection molded engineered polymer, such as, for example, a toughened nylon reinforced with up to approximately 50% of carbon fibers, glass fibers, or kevlar fibers, and operable to support a tire on a vehicle. The polymer wheel has, potentially, approximately twice the strength and half the weight of a similarly designed aluminum wheel, and may be embodied in both modular and one-piece configurations. The wheel has broad applicability to many types of vehicles and vehicular uses, and is particularly suited for use on off-road vehicles and off-road racing vehicles that are subject to punishing driving conditions.

In a preferred first modular embodiment, the wheel broadly comprises an inboard wheel half; an outboard wheel half; a center section; a bead lock ring; and a mud plug. Preferably, at least the inboard wheel half and the outboard wheel half are constructed from the polymer. The inboard wheel half provides an inboard seal and support for the tire. The inboard wheel half presents an outwardly projecting bead flange or lip operable to contact and facilitate sealing thereagainst an inboard tire bead portion of the tire. The inboard wheel half also presents a circumferential tire locking rib in relatively close proximity to the bead flange and operable to facilitate retaining the tire on the wheel by restricting movement of the inboard tire bead.

The outboard wheel half provides an outboard seal and support for the tire. The outboard wheel half presents a bead lock surface operable to contact and facilitate sealing an outboard tire bead portion of the tire thereagainst. The bead lock surface presents a first portion of an alignment mechanism in the form of a plurality of slots.

The inboard and outboard wheel halves each include a plurality of elongated stiffening ribs. The length, thickness, and number of these stiffening ribs is a matter of design and application and will depend upon a desired balance between wheel stiffness and wheel flexibility. Furthermore, the inboard and outboard wheel halves are constructed so as to have varying cross-sectional thicknesses in order to further control stiffness and flexibility. Thus, the wheel is preferably thickest and therefore stiffest at or near its center section or center portion where the wheel is coupled with the vehicle, and is preferably thinnest and therefore most flexible at or near the inboard and outboard tire beads where cracking is most likely to occur in prior art polymer wheels and where deformation is most likely to occur in prior art metal wheels.

The center section provides a mechanism for coupling the inboard wheel half with the outboard wheel half, and for coupling the wheel with the vehicle. The center section may be constructed from any suitable material, such as, for example, aluminum, magnesium, or the polymer. O-rings, gaskets, or dynamic u-cup seals are provided where the center section contacts the inboard and outboard wheels halves.

The bead lock ring is operable, in cooperation with the bead lock surface of the outboard wheel half, to facilitate sealing the outboard tire bead by clamping it therebetween. The bead lock ring is a substantially circular ring of the polymer material, and presents a second portion of the aforementioned alignment mechanism in the form of a plurality of projections which interlockingly cooperate with the plurality of slots to facilitate proper alignment of the bead lock surface with the bead lock ring. The projections also function to advantageously transfer loads during impacts, thereby further avoiding damage to the wheel.

The mud plug is operable to substantially prevent mud and debris from entering an interior cavity or area of the outboard wheel half and becoming stuck or packed therewithin. The mud plug may be adapted for use on the inboard wheel half as well by providing a center opening and slit for accommodating an axle of the wheel. Thus, the mud plug feature prevents a build-up of mud which would otherwise add undesirable weight and potentially unbalance the wheel, thereby causing undesirable vibrations. Furthermore, the mud plug ensures quick and convenient access to a valve stem inlet and to a plurality of lug bolts and nuts coupling the wheel with the vehicle. The mud plug removably couples with the wheel using quick release quarter-turn fasteners.

It will be appreciated by those with skill in the relevant arts, that the present invention provides a number of advantages over the prior art, including the stiffening ribs and varying cross-sectional thicknesses which minimize weight while substantially increasing wheel stiffness to prevent cracking or fracture failure due to driving stresses. This stiffness, however, is balanced with maintaining equally desirable energy-absorbing flexibility. Furthermore, the O-rings, gaskets, or dynamic u-cup seals interposed between the center section and both the inboard wheel half and the outboard wheel half provide a highly advantageous seal therebetween. Additionally, the interlocking alignment mechanism of the bead locking surface and bead ring facilitates easier and more convenient tire mounting and sealing. Additionally, the easily and conveniently removable mud plug provides an advantageous mechanism for preventing interior areas of the inboard and outboard wheel halves from becoming packed with mud or debris, thereby preventing unwanted added weight and vibration while ensuring quick and easy access to the valve stem for inflating the tire and to the lug nuts or other mechanisms coupling the wheel to the vehicle.

These and other important features of the present invention are more fully described in the section titled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is an isometric view of a preferred first modular embodiment of the present invention;

FIG. 2 is an exploded isometric view of the embodiment shown in FIG. 1;

FIG. 3 is an exploded isometric view of a center section component of the embodiment shown in FIG. 1;

FIG. 4 is a fragmented sectional elevation view of a dynamic u-cup seal component of the present invention;

FIG. 5 is an exploded fragmented perspective view of an outboard wheel half component and a bead ring component of the embodiment shown in FIG. 1;

FIG. 6 is a plan view of the embodiment shown in FIG. 1;

FIG. 7 is a sectional elevation view of the embodiment shown in FIG. 1 taken along line 1-1 of FIG. 6;

FIG. 8 is an exploded isometric view of a mud plug component and the bead ring component of the embodiment shown in FIG. 1;

FIG. 9 is an exploded isometric view of the mud plug component modified for inboard use;

FIG. 10 is an elevation view of a preferred second modular embodiment of the present invention; and

FIG. 11 is an isometric view of a preferred one-piece embodiment of the present invention.

### DETAILED DESCRIPTION OF A PREFERRED EMBODIMENT

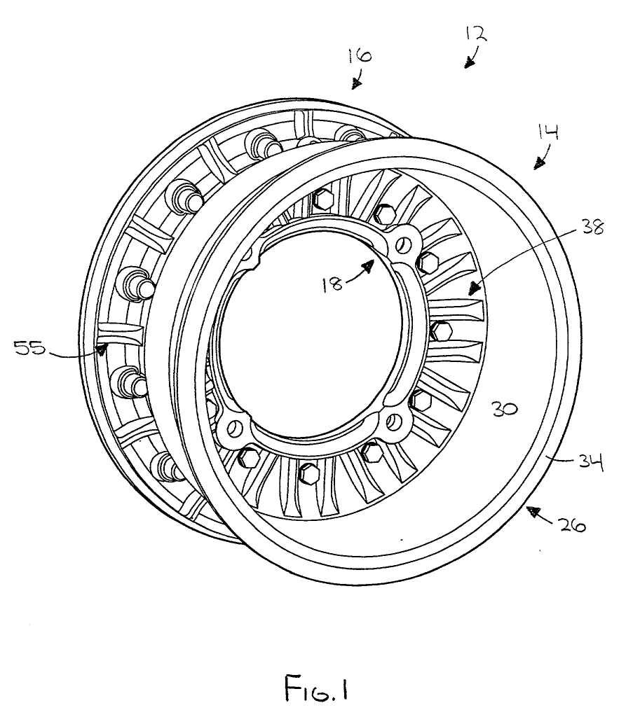

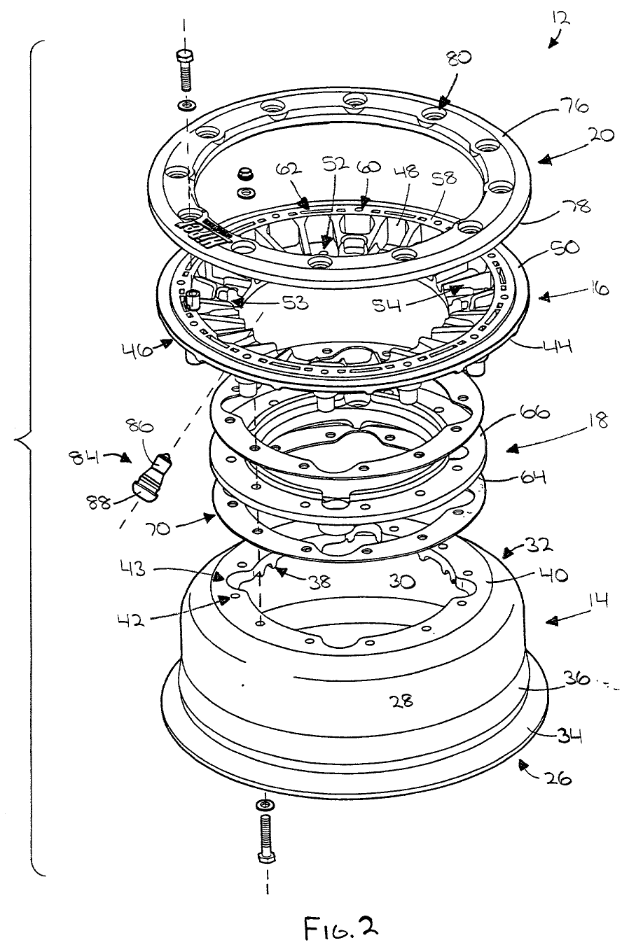

Referring to FIGS. 1-9, the present invention provides a lightweight, energy-absorbing, flexible wheel 12 constructed from an injection molded engineered polymer, and operable to support a tire on a vehicle. The wheel 12 has broad applicability to many types of vehicles and vehicular uses, and is particularly suited for use on off-road vehicles and off-road racing vehicles that are subject to punishing driving conditions. In a preferred modular embodiment, the wheel 12 broadly comprises an inboard wheel half 14; an outboard wheel half 16; a center section 18; a bead lock ring 20; and a mud plug 22.

A substantial portion of the wheel 12, particularly at least the inboard wheel half 14 and the outboard wheel half 16, are constructed from the polymer which is a toughened nylon reinforced with up to approximately 50% of carbon fibers, glass fibers, or kevlar fibers. A suitable polymer fitting this description is available, for example, from DuPont as “Zytel”, product number CDV-805.

The inboard wheel half 14 provides an inboard seal and support for the tire. The inboard wheel half 14 is substantially cylindrical, presenting an outside end 26; an exterior surface 28; an interior surface 30; and an inside end 32. The outside end 26 presents an outwardly projecting bead flange or lip 34 operable to contact and facilitate sealing thereagainst an inboard bead portion of the tire. The exterior surface 28 presents a circumferential tire locking rib 36 in relatively close proximity to the bead flange 34 and operable to facilitate retaining the tire on the wheel 12 by restricting movement of the inboard bead portion. The interior surface 30 presents a plurality of stiffening ribs 38 having a maximum thickness near the inside end 32 and extending radially or longitudinally therefrom, generally following the contour of the interior surface 30 and tapering toward the outside end 26. The length, thickness, and number of the stiffening ribs 38 is a matter of design and application and will depend upon a desired balance between wheel stiffness and wheel flexibility. Alternatively or additionally, similar stiffening ribs (not shown) may be provided on the exterior surface 28 as well. The inside end 32 provides a contact surface 40 operable to physically contact and couple with the center section 18. The contact surface 40 may be substantially flat or may provide interlocking contours, and, in either case, presents a plurality of bolt holes 42 extending completely therethrough. The inside end 32 also presents a plurality of cutouts 43 corresponding to and providing clearance for a mechanism, such as conventional lug bolts and nuts, for coupling the wheel 12 with the vehicle.

The outboard wheel half 16 provides an outboard seal and support for the tire. The outboard wheel half 16 is substantially cylindrical, presenting an inside end 44; an exterior surface 46; an interior surface 48; and an outside end 50. The inside end 44 provides a contact surface (not shown, but substantially similar to the contact surface 40 of the inboard wheel half 14) operable to physically contact and couple with the center section 18. The contact surface may be substantially flat or may provide interlocking contours, and, in either case, presents a plurality of bolt holes 52 extending completely therethrough. The inside end 44 also presents a plurality of cutouts 53 corresponding to and providing clearance for the lug bolts and nuts for coupling the wheel 12 with the vehicle. The exterior and interior surfaces 46,48 presents a plurality of stiffening ribs 54,55 that radiate axially outward from the inside end 44. The length, thickness, and number of the stiffening ribs 54,55 is a matter of design and application and will depend upon a desired balance between wheel stiffness and wheel flexibility. The outside end 50 presents a first bead lock surface 58 operable to contact and facilitate sealing an outboard bead portion of the tire thereagainst. The first bead lock surface 58 presents a plurality of internally threaded bolt holes 60 and a plurality of slots 62. The slots 62 form a first portion of an alignment mechanism which is described in more detail below.

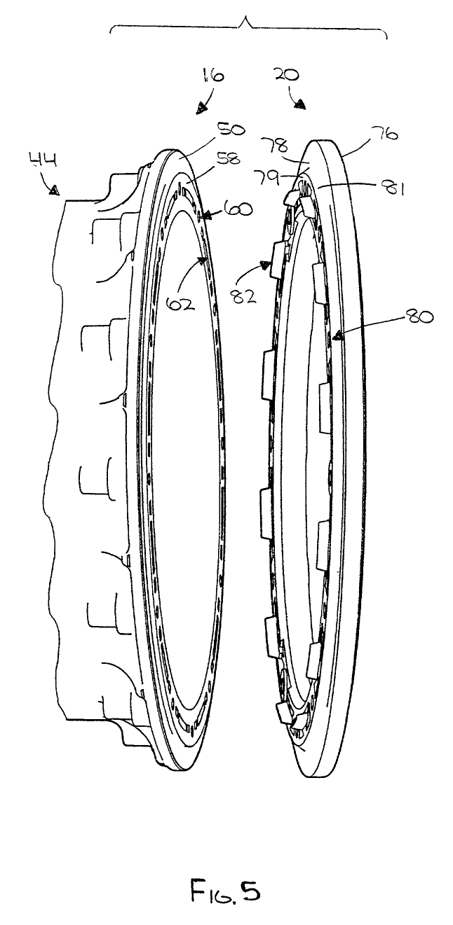

Referring particularly to FIGS. 6 and 7, the inboard wheel half 14 and the outboard wheel half 16 are constructed having varying cross-sectional thicknesses in order to control stiffness and flexibility characteristics of the wheel 12. The wheel halves 14,16 are preferably thickest at their inside ends 32,44 and generally diminish in thickness toward their outside ends 26,50, with the exception of special features, such as for example, the bead flange 34 and the circumferential tire locking rib 36. Thus, the wheel 12 will be thickest and therefore stiffest at or near its center section 18 or center portion where the wheel 12 is coupled with the vehicle, and will be thinnest and therefore most flexible near the inboard and outboard tire beads where cracking is most likely to occur in prior art polymer wheels and where deformation is most likely to occur in prior art metal wheels.

A conventional valve stem 84 is shown which allows the sealed tire to be inflated. As illustrated, the valve stem 84 extends completely through the outboard wheel half 16 to present an externally accessible air inlet 86 and a conduit 88 extending therefrom to an area corresponding to an interior area of the mounted tire.

Referring particularly to FIG. 3, the center section 18 provides a mechanism for coupling the inboard wheel half 14 with the outboard wheel half 16, and for coupling the wheel 12 with the vehicle. As illustrated, the center section 18 is constructed from billet aluminum. Extraneous material may be removed to save weight and cost. In other embodiments, the center section 18 may be constructed from any suitable material, including, for example, injection molded magnesium or the herein-described polymer.

The center section 18 presents an inboard center section contact surface 64 and an outboard center section contact surface 66. The inboard center section contact surface 64 corresponds to the contact surface 40 of the inside end 32 of the inboard wheel half 14, and will be correspondingly flat or contoured so as to securely interface therewith. Similarly, the outboard center section contact surface 66 corresponds to the contact surface of the inside end 44 of the outboard wheel half 16, and will be correspondingly flat or contoured so to securely interface therewith. The center section 18 includes first bolt holes 67 corresponding to the bolts holes 42 in the inboard wheel half 14 and the bolt holes 52 in the outboard wheel half 16. The center section 18 also provides lug bolt holes 68 for receiving the lug bolts for coupling the wheel 12 to the vehicle. Where the center section 18 is constructed from the polymer material, the lug bolts holes 68 will include compression limiting sleeves 70 operable to prevent stress on or damage to the polymer material due to tightening of the lug nuts thereon.

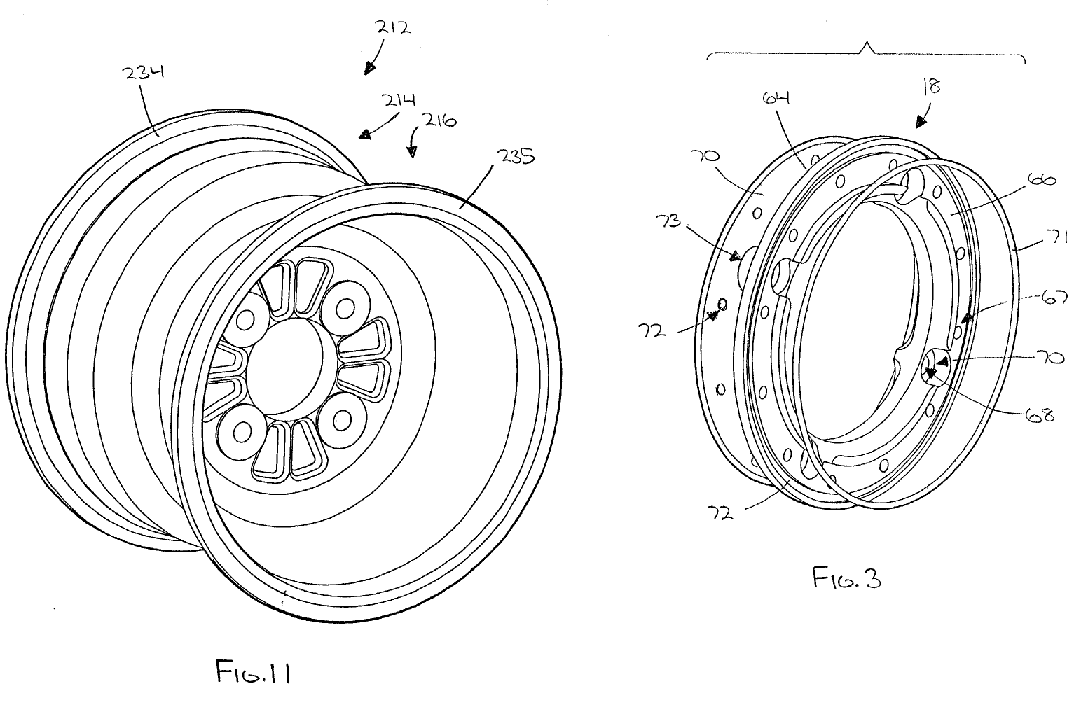

Either a gasket 70, an O-ring 71, or a dynamic u-cup seal 73 is provided for each of the center section contact surfaces 64,66 to better seal the interfaces between the center section 18 and the wheel halves 14,16. Referring particularly to FIG. 4, which shows a cross-sectional view of a typical dynamic u-cup seal 73, the dynamic u-cup seal 73 is preferred in some applications, particularly where the wheel 12 could flex sufficiently to cause the O-ring 71 to unload and unseal. The dynamic u-cup seal 73 is a conventional sealing mechanism available from a variety of sources. Where the gasket 70 is used, bolt holes 72 and cutouts 73 are provided therein which correspond, respectively, to the bolt holes 67 and lug bolt holes 68 in the center section 18. Where the O-ring 71 or the dynamic u-cup seal 73 is used, a groove 72 is provided in the contact surface 64,66 of the center section 18 for receiving such.

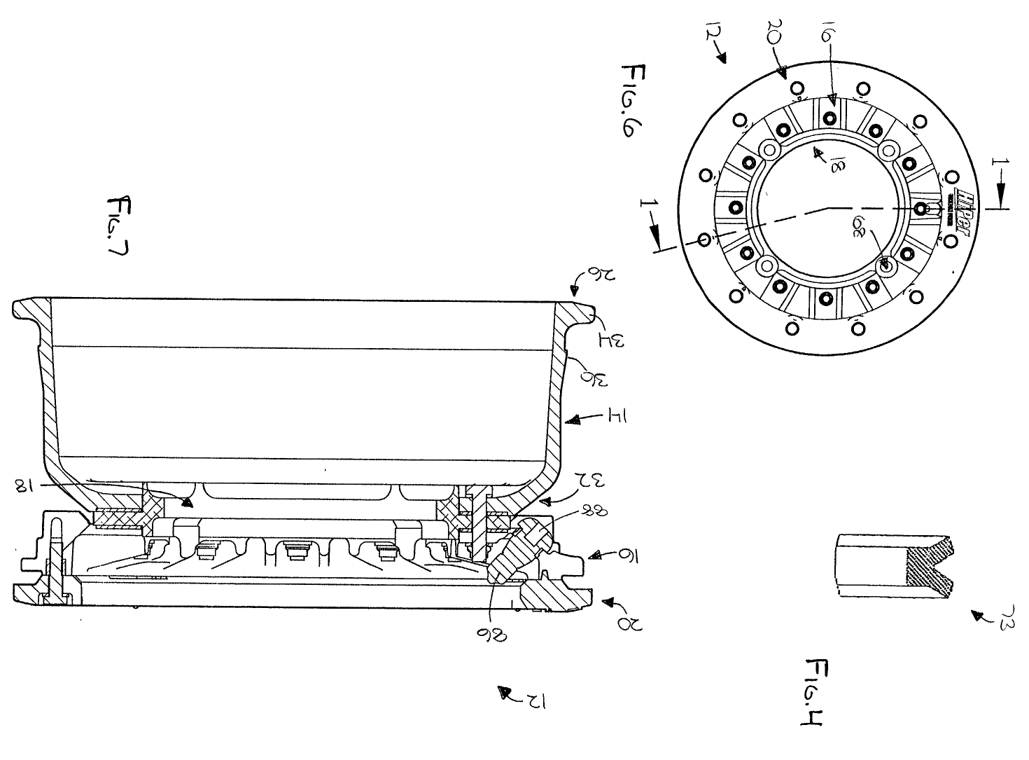

Referring particularly to FIG. 5, the bead lock ring 20 is a substantially circular ring of the engineered polymer material presenting an outer surface 76 and an inner surface 78, and a plurality of bolt holes 80 extending completely therethrough. The bolt holes 80 are preferably counter-sunk into the outer surface 76 so that the bolt heads do not protrude therepast. The inner surface 78 of the bead lock ring 20 presents a second bead lock surface 79 and a taper 81. The second bead lock surface 79 presents projections 82 corresponding to and operable to be received within and interlockingly cooperate with the slots 72 of the first bead lock surface 58 of the outside end 60 of the outboard wheel half 16. When the projections 82 are received within the slots 72, the bolt holes 60,80 will be properly aligned. Thus, the projections 82 form a second portion of the alignment mechanism mentioned above. The taper 81 facilitates properly aligning the outboard tire bead between the first and second bead locking surfaces 58,79.

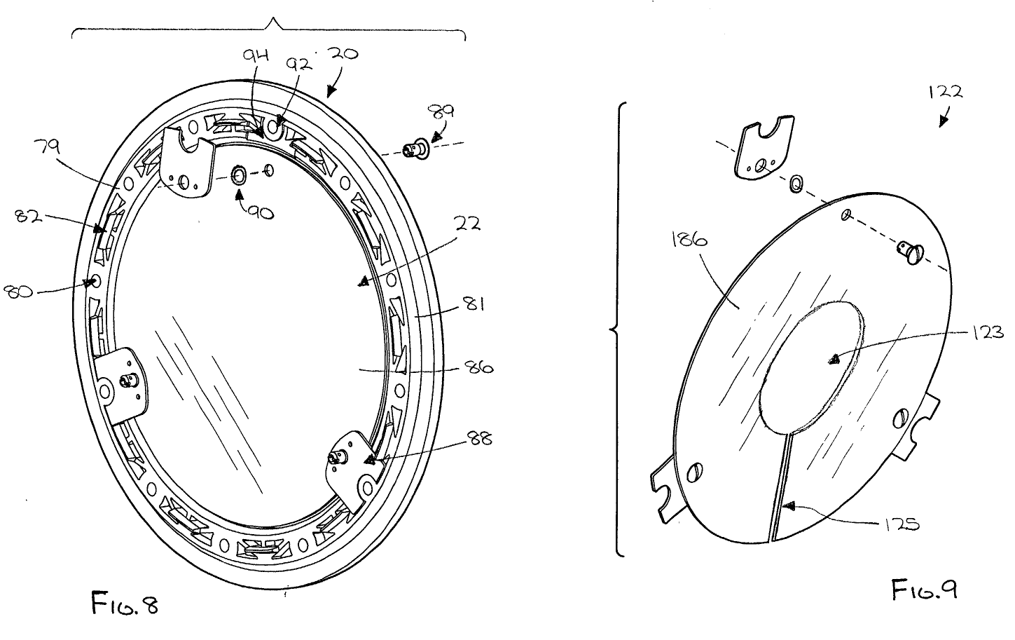

Referring particularly to FIG. 8, the mud plug 22 is operable when installed to substantially prevent mud and debris from entering the interior cavity or area of the outboard wheel half 16 and becoming stuck or packed therein. Thus, the mud plug 22 prevents a build-up of mud inside the wheel 12 which would add undesirable weight and might unbalance the wheel 12, thereby causing undesirable vibrations. Furthermore, the mud plug 22 ensures quick and convenient access to the valve stem inlet 86 and to a plurality of lug bolts and nuts coupling the wheel 12 with the vehicle.

In a preferred embodiment, the mud plug 22 includes a mud shield 86, and a plurality of mounting tabs 88. The mud shield 86 is preferably round so as to substantially cap or cover the interior area or cavity of the outboard wheel half 16. In a preferred embodiment, the mud shield 86 is constructed from a polycarbonate of between approximately 1/32 and ⅛ inch thickness. The mounting tabs 88 are removably secured between the first and second bead lock surfaces 58,79, and are operable to removably couple with the mud shield 86 using conventional quick release, quarter-turn fasteners 89. A retainer 90 is provided for each of the fasteners 89 to facilitate retaining them with the mud shield 86 when the mud shield 86 is removed from the mounting tabs 88. In a preferred embodiment, particular bolt holes 92 in the second bead lock surface 79 of the bead ring 20 have relief contouring 94 so to receive the mounting tabs 88 without interfering with the cooperative interaction between the first and second bead lock surfaces 68,79.

Referring particularly to FIG. 9, an embodiment of the mud plug 122 is shown adapted for use on the inboard wheel half 14, wherein a center opening 123 and slit 125 in the mud shield 186 is provided to accommodate a vehicle axle. The center opening 123 is sized so as to allow the axle to pass therethrough. The slit 125 allows the mud shield 186 to be opened to allow the axle to pass through to the center opening 123. Other than such accommodation of the axle, this inbooard-adapted embodiment of the mud plug functions in a manner identical to the outboard embodiment described above.

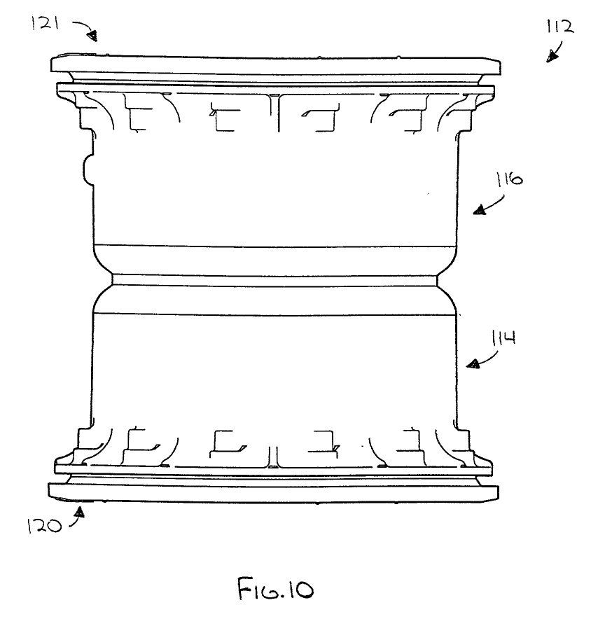

Referring also to FIG. 10, a preferred second modular embodiment of the wheel 112 is shown which is substantially similar to the preferred first embodiment described above, but in which the inboard wheel half 114 is substantially elongated and similar or identical to the outboard wheel half 116. Furthermore, the wheel 112 is shown comprising two similar or identical bead rings, including an inboard bead ring 120, associated with the inboard wheel half 114, and an outboard bead ring 121, associated with the outboard wheel half 116, thereby eliminating the bead flange 34 and the circumferential tire locking rib 36 of the preferred first modular embodiment.

Referring also to FIG. 11, in a preferred one-piece embodiment, the wheel 212 is similar in overall design and construction to the preferred modular embodiments described above. In the one-piece wheel 212, however, the distinct center section 14 is eliminated because the wheel 212 is manufactured as a single unit comprising an integral inboard portion 214 and an integral outboard portion 216 rather than the separable halves 14,16 of the modular embodiments. As illustrated, the wheel 212 includes no bead ring 20, but includes instead an inboard bead flange 234 and outboard bead flange 235.

Referring again to the wheel 12 of the first preferred modular embodiment, in exemplary use and operation the modular wheel components are initially provided in a disassembled state. During assembly, if gaskets 70 are used, the gaskets 70 are set upon the center section contact surfaces 64,66 such that the cutouts 73 of the gaskets 70 properly align with the lug bolts holes 68 of the center section 18. If O-rings 71 or dynamic u-cup seals 73 are used, they are installed by pressing them into the grooves 72 provided in the center section contact surfaces 64,66. The inboard wheel half 14 and the outboard wheel half 16 are then coupled with the center section 18 by bringing the contact surface 40 of the inside end 32 of the inboard wheel half 14 into contact with the inboard center section contact surface 64; bringing the contact surface (not shown) of the inside end 44 of the outboard wheel half 16 into contact with the outboard center section contact surface 66; aligning the bolt holes 42,67,52; passing bolts through the bolt holes 42,67,52 in the direction of the inboard wheel half 14; and applying nuts on the inboard ends of the bolts. The bolts are then torqued to specifications appropriate to the wheel design and application.

The tire is then applied to the wheel 12 by pushing or prying the tire thereupon so that the inboard tire bead is positioned between the bead flange or lip 34 and the circumferential tire locking rib 36 of the inboard wheel half 14, and the outboard bead of the tire is positioned on the first bead lock surface 58 of the outboard wheel half 16. The bead lock ring 20 is then placed upon the bead lock surface 58 such that the projections 82 align with and are received into the slots 62, thereby automatically aligning the bolt holes 60,80. The taper 81 facilitates properly aligning the tire between the first and second bead lock surfaces 58,79. Thus, the outboard bead of the tire is trapped or sandwiched between the first and second bead lock surfaces 58,79. Bolts are then threaded into the bolt holes 60,80 and tightened to seal the tire. The tire is then inflated using the valve stem 84. The wheel 12 may thereafter be conventionally mounted to the vehicle using, for example, the lug bolts and nuts or some other coupling mechanism.

If use of the mud plug 22 is desired, three bolts associated with the specially contoured bolt holes 92 of the bead ring 20 are removed; the mounting tabs 88 are inserted therein; and the bolts replaced in the bolt holes 92, thereby clamping the mounting tabs 88 between the first and second bead lock surfaces 58,79. The mud shield 86 may then be installed and removed, as desired, without removing the mounting tabs 88, by using the quick release quarter-turn fasteners 89. When the mud shield is removed 86, the retainers 90 retain the fasteners 89 thereupon to prevent loss.

For the preceding description, it will be appreciated that the present invention provides a lightweight, energy-absorbing, flexible vehicle wheel constructed from an injection molded engineered polymer, such as, for example, a toughened nylon reinforced with up to approximately 50% of carbon fibers, glass fibers, or kevlar fibers. The polymer wheel has, potentially, twice the strength and half the weight of aluminum wheels of similar design, and may be embodied in modular or one-piece designs. The wheel has general applicability to many types of vehicles and vehicular uses, and is particularly suited for use on off-road vehicles and off-road racing vehicles that are subject to punishing driving conditions. The wheel provides a number of advantages over existing wheels, including ribs and varying cross-sectional thicknesses that substantially increase wheel stiffness, thereby helping to prevent cracking or fracture failure due to driving stresses. This stiffness, however, is balanced with maintaining equally desirable energy-absorbing abilities and flexibility qualities. Furthermore, the gaskets, O-rings, or dynamic u-cup seals interposed between the center section and both the inboard and outboard wheel halves provide a highly advantageous seal therebetween. Additionally, the interlocking alignment mechanism of the first and second bead locking surfaces facilitate easier and more convenient tire mounting and sealing. Additionally, the easily and conveniently removable mud plug provides an advantageous mechanism for preventing the interior area or cavity of the inboard and outboard wheel halves from becoming packed with mud or debris, thereby preventing a build-up of weight-adding mud which might unbalance the wheel and cause undesirable vibration, while ensuring quick and easy access to the valve stem for inflating the tire and to the lug nuts or other mechanism coupling the wheel to the vehicle.

Although the invention has been described with reference to the preferred embodiments illustrated in the attached drawings, it is noted that equivalents may be employed and substitutions made herein without departing from the scope of the invention as recited in the claims. For example, the wheel's dimensions, including radius and depth will vary depending on each particular contemplated application. Furthermore, as will be appreciated from the various described embodiments, the wheel may include two bead flanges and no bead locking rings; two bead locking rings and no beads flanges; or one bead flange and one bead locking ring.

Having thus described the preferred embodiment of the invention, what is claimed as new and desired to be protected by Letters Patent includes the following:

1. A wheel for mounting on a vehicle, the wheel comprising a polymer reinforced with up to approximately 50% of fibers.

2. The wheel as set forth in claim 1, wherein the polymer is a toughened nylon.

3. The wheel as set forth in claim 1, wherein the fibers are glass fibers.

4. The wheel as set forth in claim 1, wherein the fibers are carbon fibers.

5. The wheel as set forth in claim 1, wherein the fibers are kevlar fibers.

5. The wheel as set forth in claim 1, wherein the wheel is cross-sectionally thickest near a center portion of the wheel and tapers to diminishing cross-sectional thickness thereoutward.

6. The wheel as set forth in claim 1, further comprising a plurality of stiffening ribs.

7. A wheel for mounting on a vehicle, the wheel comprising a fiber reinforced toughened nylon including up to approximately 50% of fibers selected from the group consisting of: glass fibers, carbon fibers, and kevlar fibers, and comprising a plurality of stiffening ribs, and wherein the wheel is cross-sectionally thickest near a center portion of the wheel and tapers to diminishing cross-sectional thickness thereoutward.

8. A modular wheel for mounting on a vehicle, the wheel comprising:
an inboard wheel half;
an outboard wheel half;
a center section interposed between and separably coupled with the inboard wheel half and the outboard wheel half; and
a first bead lock ring having a first bead lock surface, wherein the wheel presents a second bead lock surface such that the first bead lock surface and the second bead lock surface cooperate to facilitate sealing a first bead of a tire therebetween.

9. The modular wheel as set forth in claim 8, wherein the inboard wheel half includes a plurality of stiffening ribs.

10. The modular wheel as set forth in claim 8, wherein the inboard wheel half presents an exterior surface having a circumferential raised rib operable to facilitate retaining a tire on the wheel.

11. The modular wheel as set forth in claim 8, wherein the outboard wheel half includes a plurality of stiffening ribs.

12. The modular wheel as set forth in claim 8, wherein the outboard wheel half and the inboard wheel half are constructed from a polymer.

13. The modular wheel as set forth in claim 12, wherein the polymer is a toughened nylon.

14. The modular wheel as set forth in claim 12, wherein the polymer is reinforced with up to approximately 50% of fibers selected from the group consisting of: carbon fibers, glass fibers, and kevlar fibers.

15. The modular wheel as set forth in claim 8, wherein the center section is constructed from aluminum.

16. The modular wheel as set forth in claim 8, wherein the center section is constructed from magnesium.

17. The modular wheel as set forth in claim 8, wherein the center section is constructed from a polymer and includes a compression limiting insert.

18. The modular wheel as set forth in claim 17, wherein the compression limiting insert is molded into the polymer.

19. The modular wheel as set forth in claim 8, wherein the center section presents a first center section contact surface for close contact with a corresponding contact surface of the inboard wheel half, and presents a second center section contact surface for close contact with a corresponding contact surface of the outboard wheel half, and the first center section contact surface and the second center section contact surface includes a groove for receiving an O-ring seal.

20. The modular wheel as set forth in claim 8, wherein the center section presents a first center section contact surface for close contact with a corresponding contact surface of the inboard wheel half, and presents a second center section contact surface for close contact with a corresponding contact surface of the outboard wheel half, and the first center section contact surface and the second center section contact surface includes a groove for receiving a dynamic u-cup seal.

21. The modular wheel as set forth in claim 8, wherein the first bead lock surface presents a first portion of an alignment mechanism, and the second bead lock surface presents a second portion of the alignment mechanism, wherein the first portion and the second portion of the alignment mechanism cooperate to align a first bolt hole in the first bead lock surface with a second bolt hole in the second bead lock surface.

22. The modular wheel as set forth in claim 8, further comprising a second bead lock ring having a third bead lock surface, wherein the wheel presents a fourth bead lock surface such that the third bead lock surface and the fourth bead lock surface cooperate to facilitate sealing a second bead of the tire therebetween.

23. The modular wheel as set forth in claim 8, further comprising a mud plug positioned within the outboard wheel half and operable to prevent substantial entry thereinto of mud and debris.

24. The modular wheel as set forth in claim 23, wherein the mud plug is removably secured within the outboard wheel half using a quick release fastener.

25. A modular wheel for mounting on a vehicle, the wheel comprising:
an inboard wheel half having a first plurality of stiffening ribs and having a circumferential raised rib operable to facilitate retaining a tire on the wheel;
an outboard wheel half having a second plurality of stiffening ribs and a first bead lock surface presenting a first bolt hole and a first portion of an alignment mechanism;
a center section interposed between and separably coupled with the inboard wheel half and the outboard wheel half;
a bead lock ring having a second bead lock surface presenting a second bolt hole and a second portion of the alignment mechanism, wherein the first portion cooperates with the second portion to thereby align the first bolt hole of the first bead lock surface with the second bolt hole of the second bead lock surface; and
a mud plug removably secured within the outboard wheel half using a quick release fastener, and operable to prevent substantial entry thereinto of mud and debris.

26. The modular wheel as set forth in claim 25, wherein the center section presents a first center section contact surface for close contact with a corresponding contact surface of the inboard wheel half, and presents a second center section contact surface for close contact with a corresponding contact surface of the outboard wheel half, and the first center section contact surface and the second center section contact surface includes a groove for receiving an O-ring seal.

27. The modular wheel as set forth in claim 25, wherein the center section presents a first center section contact surface for close contact with a corresponding contact surface of the inboard wheel half, and presents a second center section contact surface for close contact with a corresponding contact surface of the outboard wheel half, and the first center section contact surface and the second center section contact surface includes a groove for receiving a dynamic u-cup seal.

28. A wheel for mounting on a vehicle, the wheel comprising:
a wheel body including an inboard portion and an outboard portion; and
a first bead lock ring having a first bead lock surface, wherein the wheel presents a second bead lock surface such that the first bead lock surface and the second bead lock surface cooperate to facilitate sealing a first bead of a tire therebetween.

29. The wheel as set forth in claim 28, wherein the inboard wheel portion includes a plurality of stiffening ribs.

30. The wheel as set forth in claim 28, wherein the inboard wheel portion presents an exterior surface having a circumferential raised rib operable to facilitate retaining a tire on the wheel.

31. The wheel as set forth in claim 28, wherein the outboard wheel portion includes a plurality of stiffening ribs.

32. The wheel as set forth in claim 28, wherein the wheel body is substantially constructed from a polymer.

33. The wheel as set forth in claim 32, wherein the polymer is a toughened nylon.

34. The wheel as set forth in claim 32, wherein the polymer is reinforced with up to approximately 50% of fibers selected from the group consisting of: carbon fibers, glass fibers, and kevlar fibers.

35. The wheel as set forth in claim 28, wherein the first bead lock surface presents a first portion of an alignment mechanism, and the second bead lock surface presents a second portion of the alignment mechanism, wherein the first portion and the second portion of the alignment mechanism cooperate to align a first bolt hole in the first bead lock surface with a second bolt hole in the second bead lock surface.

36. The wheel as set forth in claim 28, further comprising a second bead lock ring having a third bead lock surface, wherein the wheel presents a fourth bead lock surface such that the third bead lock surface and the fourth bead lock surface cooperate to facilitate sealing a second bead of the tire therebetween.

37. The wheel as set forth in claim 28, further comprising a mud plug positioned within the outboard wheel portion and operable to prevent substantial entry thereinto of mud and debris.

38. The wheel as set forth in claim 37, wherein the mud plug is removably secured within the outboard wheel half using a quick release fastener.

39. A wheel for mounting on a vehicle, the wheel comprising:
a first bead lock surface presenting a first bolt hole and presenting a first portion of an alignment mechanism; and
a bead lock ring having a second bead lock surface and presenting a second bolt hole and a second portion of the alignment mechanism,
wherein the first portion of the alignment mechanism cooperates with the second portion to thereby align the first bolt hole of the first bead lock surface with the second bolt hole of the second bead lock surface, and the first bead lock surface and the second bead lock surface cooperate to facilitate sealing a bead of a tire therebetween.

40. The wheel as set forth in claim 39, wherein the alignment mechanism includes a projection and a corresponding slot, wherein the projection fits within the corresponding slot.

41. The wheel as set forth in claim 39, wherein the first bolt hole is internally threaded.

42. The wheel as set forth in claim 39, wherein the bead lock ring presents an outer surface, and the second bolt hole is countersunk within the outer surface.

43. The wheel as set forth in claim 39, further including a taper on the second bead lock surface operable to properly align the bead of the tire thereon.

44. A wheel for mounting on a vehicle, the wheel comprising:
an outboard cavity through which access is had to a mechanism for removably coupling the wheel with the vehicle; and
a mud plug removably secured to the wheel half using a quick release fastener, and operable to substantially prevent entry of mud and debris into the outboard cavity.

45. The wheel as set forth in claim 44, wherein the mud plug includes a mounting tab removably secured to the wheel, and a mud shield removably secured to the mounting tab.

46. The wheel as set forth in claim 44, wherein the quick release fastener is a quarter-turn fastener.

47. The wheel as set forth in claim 44, wherein the mud plug is provided with a center hole for accommodating an axle of the vehicle.
